(19) United States
(12) Patent Application Publication
(10) Pub. No.: US 2007/0102889 A1
(43) Pub. Date: May 10, 2007

(54) Tool handle assembly

(75) Inventor: Peter (Hao) Wen, Shanghai (CN)

Correspondence Address: EDMONDS, P.C., 16815 ROYAL CREST DRIVE, SUITE 130, HOUSTON, TX, 77058, US

(73) Assignee: KRAFTOOL MFG. (SHANGHAI) CO., LTD., SHANGHAI (CN)

(21) Appl. No.: 11/586,435

(22) Filed: Oct. 25, 2006

(30) Foreign Application Priority Data
Oct. 26, 2005 (CN) 200510030724.1

(51) Int. Cl. B23B 31/12

(52) U.S. Cl. 279/43

(57) ABSTRACT

A tool handle assembly is provided. The tool handle assembly can include a handle with an outer casing and a chuck jaw. The chuck jaw is adapted to move back and forth, and is disposed outside a conical section formed at one end of the outer casing. The chuck jaw can be connected via friction between an inner surface of the chuck jaw and a conical surface of the outer casing. A longitudinal hole used for installing the tool can be formed at the center of the conical section of the outer casing. Advantages of the tool handle assembly include simple and safe use and faster attachment/detachment of a tool.

### CROSS REFERENCE TO RELATED APPLICATION

This application claims the benefit under 35 USC §119 of Chinese Patent Application having Ser. No. 200510030724.1 filed on Oct. 26, 2005, which is incorporated by reference herein.

### BACKGROUND OF THE INVENTION

1. Field of the Invention

Embodiments of the present invention generally relate to a tool handle assembly. More particularly, embodiments of the present invention relate to a tool handle assembly that allows a tool to be detached quickly to increase safety and usefulness of the tool.

2. Description of the Related Art

Conventional tool handle assemblies have long outer casings, which have positions for metallic conical chucks with holes inside. The working base of a tool handle assembly uses connections realized by screw threads. In order to insert the tool into a plastic casing, an operator applies pressure to the outside of the tool so that the chuck on the other side leaves the plastic casing. A metal bolt is applied at the end of the working surface to permit the chuck to fix the tool to the handle. Problems with this conventional tool handle assembly include a complex screw thread connection and inaccurate positioning of the handle. In addition, the operator of the conventional tool handle assembly may not be able to quickly detach the tool, resulting in disadvantages of safety and comfort.

There is a need, therefore, for a tool handle assembly that allows the tool to be detached quickly to increase the safety and usefulness of the tool.

### SUMMARY OF THE INVENTION

In one or more embodiments, the present invention generally relates to a tool handle assembly including a long outer casing and a chuck jaw. In one or more embodiments, the chuck jaw can be moved back and forth, installed outside a conical part at one end of the long outer casing, and/or can be connected via friction between the inner surface of the chuck jaw and the conical surface of the long outer casing. In one or more embodiments, a longitudinal hole used for installing the tool can additionally be formed at the center of the conical part at one end of the long outer casing.

In one or more embodiments, one end of the long outer casing can be shaped like a wide circular cap and a conical part can be formed at the other end. In one or more embodiments, the conical part can extend to the concave part in the wide cap. In one or more embodiments, a conical hole that matches the conical part at the end of the long outer casing can be formed in the aforementioned chuck jaw.

The present invention provides a reliable tool handle assembly whereby a tool can advantageously be detached easily and quickly. Further, a wide cap of a long outer casing can allow for safety during use.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a partial cross section of a tool handle assembly in accordance with one or more embodiments described.

FIG. 2 depicts a cross-sectional view of the tool handle assembly of FIG. 1 along lines A-A in accordance with one or more embodiments described.

### DETAILED DESCRIPTION OF THE PREFERRED EMBODIMENT

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

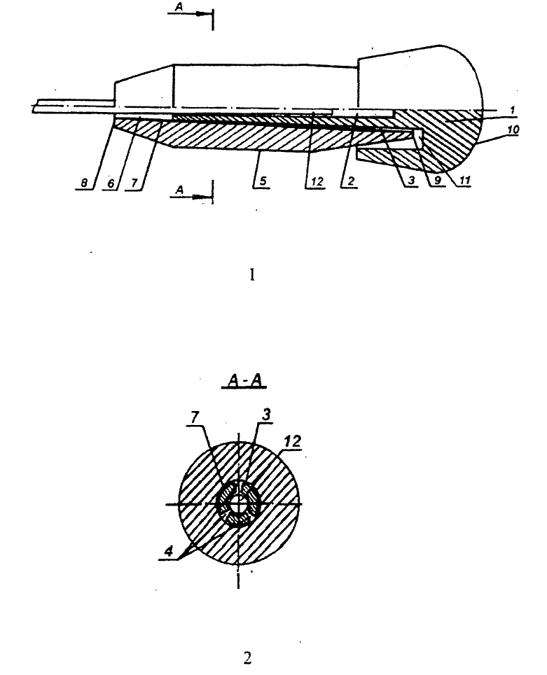

FIG. 1 depicts a partial cross section of a tool handle assembly in accordance with one or more embodiments described. The tool handle includes an outer casing 1 and a chuck jaw 5. A first end of the outer casing 1 can be shaped like a bulbous or a wide circular cap 10 while a second end thereof can be conical or tapered. In one or more embodiments, the conical end can be extended to a concave part 11 of the cap 10. In one or more embodiments, a conical hole that matches the conical part at the end of long outer casing 1 can be formed in the chuck jaw 5. In one or more embodiments, the chuck jaw 5 can be moved back and forth and installed outside one end of long outer casing 1. In one or more embodiments, a rear end surface 9 of the chuck jaw 5 can enter the concave part 11 of the wide cap 10 of the long outer casing 1. In one or more embodiments, a longitudinal hole 2 can be used for installing the tool and can be formed at the center of the conical part at one end of long outer casing 1.

FIG. 2 depicts a cross-sectional view of the tool handle assembly of FIG. 1 along lines A-A in accordance with one or more embodiments described. In one or more embodiments, connection of the chuck jaw 5 can be realized via friction between an inner surface 7 of the chuck jaw 5 and a conical surface 3 of the long outer casing 1. In one or more embodiments, the handle assembly can include the long outer casing 1 and chuck jaw 5 in a non-working state. In one or more embodiments, a tool can be clamped if a round tail part 12 of the tool handle assembly can be inserted into the longitudinal hole 2 of the long outer casing 1, through a working surface 8 of the chuck jaw 5, and through hole 6. In one or more embodiments, the chuck jaw 5 can clamp the long outer casing 1 via the conical surface 3 to reduce the area of space 4 between the tail part 12 and the longitudinal hole 2 so that the tail part 12 of the tool handle assembly can be easily assembled. Clamping the inner surface 7 of the chuck jaw 5, the outer conical surface 3 of long outer casing 1, and the tail part 12 of the tool can be accomplished as depicted in FIG. 2. In one or more embodiments, the chuck jaw 5 can be held and moved to fix the wide cap 10 so that the tool handle assembly can clamp and release the tool.

In one or more embodiments, the long outer casing and the chuck jaw can be connected via friction between the inner surface of the chuck jaw and the outer surface of the long outer casing to form a special chuck. During operation of the tool handle assembly, a tool can be inserted into the longitudinal hole 2 at the center of the conical part at one end of the outer casing 1 and the operator can push the chuck jaw 5 inwards to clamp the tool. After the operator finishes using the tool handle assembly, the chuck jaw can be moved outwards to detach the tool.

In another embodiment, the present invention generally relates to:

1. A tool handle assembly comprising: an outer casing and a chuck jaw; the chuck jaw, adapted to move back and forth, and disposed outside a conical section at one end of outer casing, wherein the chuck jaw is connected via friction between an inner surface of the chuck jaw and the conical section of the outer casing; a longitudinal hole used for installing a tool in the hole formed at the center of the conical section of the outer casing.

2. The tool handle assembly of paragraph 1, wherein one end of the long outer casing (1) can be shaped like a circular wide cap (10). A conical part can be formed at the other end and the conical part can be extended to the concave part (11) of the wide cap (10).

3. The tool handle assembly of any of paragraphs 1 to 2, wherein a conical hole that matches the conical part at the end of long outer casing (1) can be formed in the chuck jaw (5).

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A tool handle assembly comprising: an outer casing and a chuck jaw; the chuck jaw, adapted to move back and forth, and disposed outside a conical section at one end of outer casing, wherein the chuck jaw is connected via friction between an inner surface of the chuck jaw and the conical section of the outer casing; a longitudinal hole used for installing a tool in the hole formed at the center of the conical section of the outer casing.

2. The tool handle assembly of claim 1, wherein one end of said long outer casing is shaped like a circular wide cap, while a conical part is formed at the other end, which is extended to the concave part of wide cap.

3. The tool handle assembly of claim 1, wherein a conical hole that matches the conical part at the end of long outer casing is formed in chuck jaw.
